(19) United States
(12) Patent Application Publication
(10) Pub. No.: US 2007/0275667 A1
(43) Pub. Date: Nov. 29, 2007

(54) Parallel test of portable wireless multimedia devices

(76) Inventors: Hung Fung Leung, Kowloon (HK); Sang-chel Koh, Seoul (KR)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/440,729

(22) Filed: May 25, 2006

(51) Int. Cl. H04B 17/00

(52) U.S. Cl. 455/67.14

(57) ABSTRACT

A single box tester allows for simultaneous testing of digital video and digital communications capabilities of a device under test. An arbitrary waveform generator is used to generate a test signal suitable for testing DTV receivers operating using standards such as DVB-H or T-DMB, while simultaneously a test signal generator and receiver allow testing of communications capabilities of the device using standards such as EGPRS, GSM/EDGE-(GSM900, GSM1800) or WCDMA.

### TECHNICAL FIELD

Embodiments in accordance with the invention are related to testing of wireless devices, and more particularly to testing of wireless devices with multimedia capabilities.

### BACKGROUND

Complex wireless digital devices require testing during the manufacturing process to verify compliance with specifications. Modern mobile electronic devices incorporate not only digital communications such as the ability to send and receive text and voice messages, but also the ability to receive and display digital television signals (DTV) using transmission standards such as DVB-H, Korean T-DMB based on the European DAB Eureka 147 transmission standard, and so on.

The Digital Video Broadcasting-Handheld (DVB-H) Standard is described, for example, in “DVB-H: Digital Broadcast Services to Handheld Devices” by Faria et al., published in The Proceedings of the IEEE, Vol. 94, No. 1, January 2006, pp 194-209 and incorporated herein by reference. Also applicable are the “DVB-H Implementation Guidelines”, DVB Document A092, July 2005, incorporated herein by reference, and the European Standard ETSI EN 302 304 V 1.1.1 (2004-11) entitled “Digital Video Broadcasting (DVB); Transmission System for Handheld Terminals (DVB-H)” also incorporated herein by reference.

Example devices may combine digital television reception with GSM/EDGE or WCDMA cellular radio transmission and reception. The manufacturer of such devices must verify correct operation of not only correct DVB operation, but also correct cellular radio operation, and combined operation digital television and cellular radio.

### SUMMARY OF THE INVENTION

A single-box tester provides for testing of a digital device under test (DUT). The tester provides for simultaneous testing of digital video and digital communications subsystems in the DUT. An arbitrary waveform generator (ARB) generates a test signal which allows the digital video portion of the DUT to measure a bit error rate of the video signal at the same time the digital communications portion of the DUT is being tested.

### BRIEF DESCRIPTION OF THE DRAWINGS

FIG. 1 shows a frequency spectrum,

FIG. 2 shows a block diagram of a first mobile device,

FIG. 3 shows a block diagram of a second mobile device, and

FIG. 4 shows an block diagram of a single box tester.

### DETAILED DESCRIPTION OF THE EMBODIMENTS

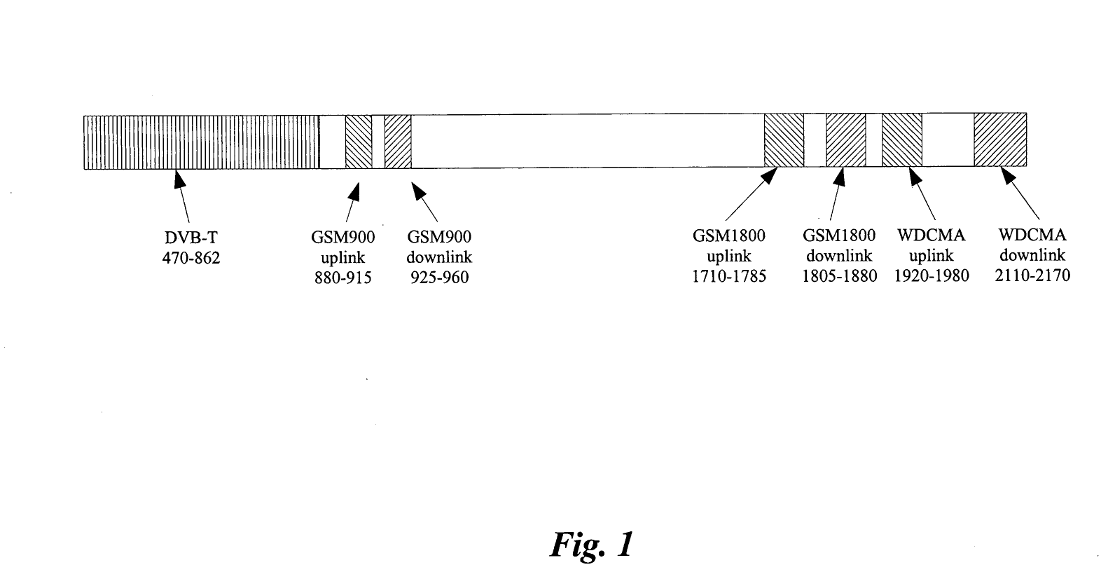

Modern mobile digital devices combine multimedia capabilities with two-way communications. FIG. 1 shows a frequency spectrum for devices of this type. Under international standards, digital television channels such as DVB-T and T-DMB occupy the 470-862 MHz portion of the electromagnetic spectrum. Two-way communications using the WCDMA standard known to the art, which may include HSDPA and HSUPA high speed download/upload packet access, use uplink channels from the portable device to base stations in the 1920 to 1980 MHz range, and downlink to portable devices in the 2110 to 2170 MHz range. Two-way communications using industry standard EGPRS modes, which include GSM, GPRS, and EDGE as known to the art may operate in two frequency bands. GSM900 uplinks in 880-915 MHz, and downlinks in 925-960 MHz. GSM1800 uplinks 1710-1785 MHz, and downlinks 1805-1880 MHz.

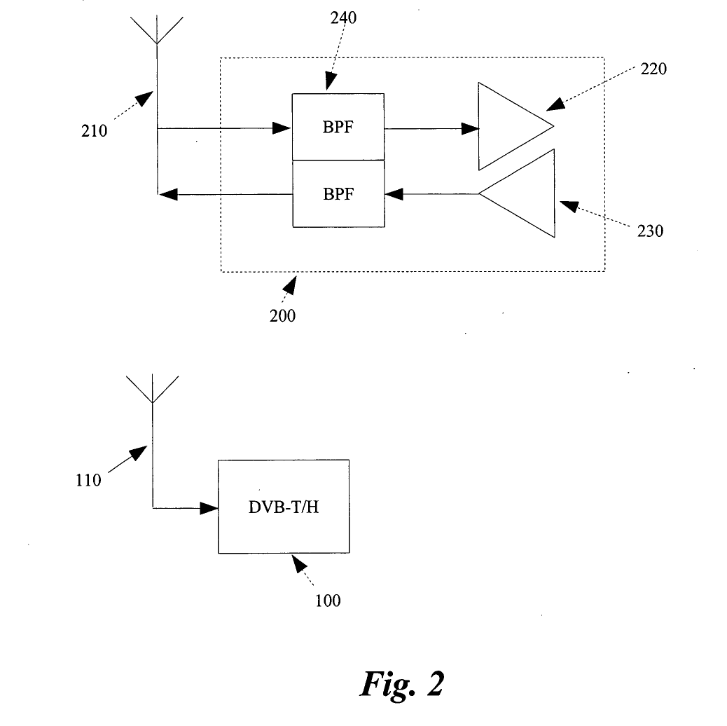

FIG. 2 shows a block diagram of the RF section of a combined DVB plus WCDMA device. DVB-T/H receiver 100 receives its signal from antenna 110. WCDMA RF section 200 uses antenna 210. Receiver low noise amplifier (LNA) 220 and transmitter power amplifier (PA) 230 connect to antenna 210 through duplexer 240. Duplexer 240 is a pair of carefully crafted bandpass filters (BPF) which pass transmit (TX) and receive (RX) signals, allowing both TX and RX channels to be active at the same time, at the same time providing isolation between TX and RX channels.

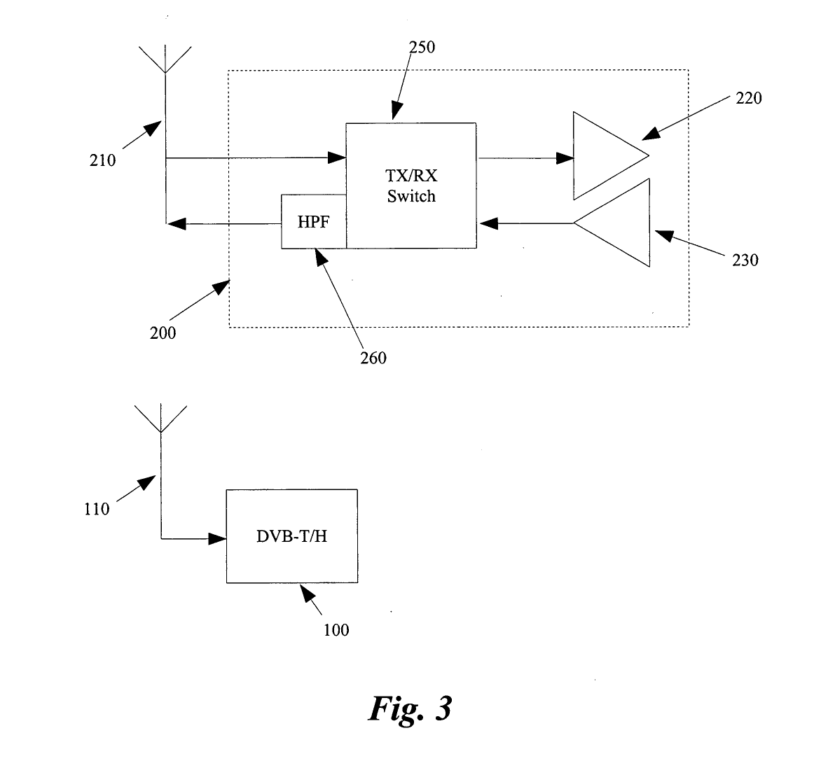

FIG. 3 shows a block diagram of the RF section of a combined DVB pus GSM/EDGE device. DVB-T/H receiver 100 uses antenna 110. GSM/EDGE RF section 200 uses antenna 210. Receiver low noise amplifier (LNA) 220 and transmitter power amplifier (PA) 230 connect to antenna 210 through TX/RX switch 250 and transmit high-pass filter (HPF) 260.

While the devices shown in FIGS. 2 and 3 show separate antennas 110 and 210, these antennas could be combined.

As stated in the Annex B of the DVB-H Implementation Guidelines, the co-existence and simultaneous operation of several radios in small enclosure, such as those shown in FIGS. 2 and 3, leads to a number of design challenges. Of particular interest are interactions between the cellular transmitter and the DVB receiver.

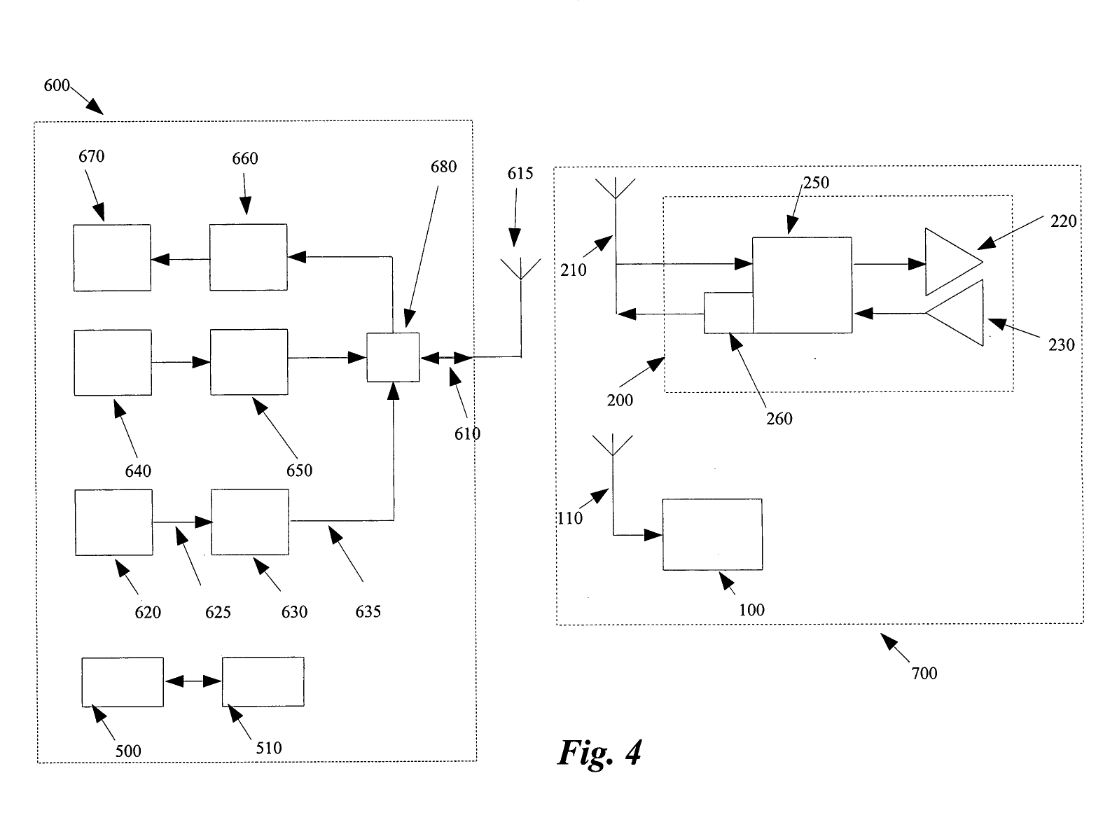

FIG. 4 shows a single box tester according to the present invention. Test set 600 transmits and receives RF signals 610 for testing device under test (DUT) 700, which is a combined cellular and DTV device such as those shown in FIGS. 2 and 3. As shown, test set 600 uses antenna 615 to communicate with DUT 700. A wired connection may also be used. In many environments, it may be necessary to enclose antenna 615 and DUT 700 within a shielded enclosure. Test set 600 contains two signal sources and one receiver. In one embodiment, test set 600 is a computer controlled device containing CPU 500 and memory hierarchy 510. For clarity, interconnections among the CPU, memory, and subsystems of the test set are not shown. Also not shown are standard subsystems such as power supplies, displays, keyboards, and the like. A first signal source uses arbitrary waveform generator (ARB) 620 to generate signal 625 which is passed to upconverter/modulator 630. Upconverter/modulator 630 produces RF output signal 635 which is fed to RF splitter/combiner 680. A second signal source is generated by source 640 which feeds upconverter/modulator 650. The RF output of upconverter/modulator 650 also feeds splitter/combiner 680. Splitter/combiner 680 also feeds downconverter 660 and decoder/demodulator 670 which form the receive channel. Splitter/combiner 680 may be a single multi-port device, or a connection of devices with two or more ports. In operation, CPU 500 controls the operating frequencies and signal levels of upconverter/modulators 630 and 650, as well as the receive frequency of downconverter 660.

According to the present invention, test set 600 uses arbitrary waveform generator 620 to generate a formatted digital bitstream which allows DTV receiver 110 in DUT 700 to measure a bit error rate (BER). The output 625 of ARB 620 may be a composite signal or an I-Q signal feeding upconverter/modulator 630.

Simultaneously with the generation of test signal 635, the second signal source 640, 650 and the receive channel formed by downconverter 660 and demodulator 670 allow for testing of the cellular communications capabilities of DUT 700. Typical tests performed on DUT 700 include but are not limited to spectral purity and stability, power output, bit error rate, switching times, and sensitivity.

While the embodiments of the present invention have been illustrated in detail, it should be apparent that modifications and adaptations to these embodiments may occur to one skilled in the art without departing from the scope of the present invention as set forth in the following claims.

1. A method of testing a portable wireless device using a single box tester having a first RF signal generator and a first RF signal receiver for a first signal band, and a second RF signal generator for a second signal band, the method comprising:
testing the device under test using the first RF signal generator and the first RF signal receiver,
generating a digital test signal using an arbitrary waveform generator,
applying the digital test signal to a modulator forming a second RF signal, and
simultaneously providing the second RF signal to the device under test while testing the device under test using the first RF signal generator and the first RF signal receiver.

2. The method of claim 1 where the second RF signal allows for testing of a device under test using DVB-H.

3. The method of claim 1 where the second RF signal allows for bit error rate testing of a device under test using DVB-H.

4. The method of claim 1 where the second RF signal allows for testing of a device under test using T-DMB.

5. The method of claim 1 where the second RF signal allows for bit error rate testing of a device under test using T-DMB.

6. The method of claim 1 where the first RF signal generator and the RF signal receiver allows for testing of a device under test using EGPRS.

7. The method of claim 1 where the first RF signal generator and the RF signal receiver allows for testing of a device under test using GSM.

8. The method of claim 1 where the first RF signal generator and the RF signal receiver allows for testing of a device under test using GPRS.

9. The method of claim 1 where the first RF signal generator and the RF signal receiver allows for testing of a device under test using EDGE.

10. The method of claim 1 where the first RF signal generator and the RF signal receiver allows for testing of a device under test using GSM900.

11. The method of claim 1 where the first RF signal generator and the first RF signal receiver allows for testing of a device under test using GSM1800.

12. The method of claim 1 where the first RF signal generator and the first RF signal receiver allows for testing of a device under test using WCDMA.

13. The method of claim 1 where the first RF signal generator and the RF signal receiver allows for testing of a device under test using HSDPA/HSUPA.

14. A single-box tester for testing wireless devices comprising:
a first signal source comprising an arbitrary waveform generator and a first upconverter/modulator,
a second signal source capable of simultaneous operation with the first signal source comprising a signal generator and a second upconverter/modulator, and
a receiver capable of simultaneous operation with the first and second signal sources comprising a downconverter and a demodulator.

15. The single-box tester of claim 14 further comprising a signal splitter/combiner for connecting the output of the first signal source, the output of the second signal source, and the input of the receiver to a common signal line.

16. The single box tester of claim 14 where one of the signal sources is capable of generating a test signal for testing DVB-H communications and simultaneously generating using the other signal source a test signal for testing communications under one or more of EGPRS, GSM, GPRS, EDGE, or WDCMA.

17. The single box tester of claim 14 where one of the signal sources is capable of generating a test signal for testing T-DMB communications and simultaneously generating using the other signal source a test signal for testing communications under one or more of EGPRS, GSM, GPRS, EDGE, or WDCMA.
